(19) United States
(12) Patent Application Publication
(10) Pub. No.: US 2015/0030850 A1
(43) Pub. Date: Jan. 29, 2015

(54) RE-PEELABLE PROTECTIVE ADHESIVE FILM, AND METHOD OF MANUFACTURING SAME

(71) Applicant: KIMOTO CO., LTD, Saitama-shi, Saitama (JP)

(72) Inventors: Hironori Sato, Saitama (JP); Junji Ichinokawa, Saitama (JP); Mitsunori Maruyama, Saitama (JP)

(73) Assignee: KIMOTO CO., LTD., Saitama-shi, Saitama (JP)

(21) Appl. No.: 14/379,687

(22) PCT Filed: Feb. 25, 2013
(86) PCT No.: PCT/JP2013/054734

§ 371 Date: Aug. 19, 2014

(30) Foreign Application Priority Data
Feb. 29, 2012 (JP) 2012-043234

(51) Int. Cl. C09J 175/04; B05D 3/10; B05D 7/00; B05D 1/38; B05D 5/00

(52) U.S. Cl. CPC C09J 175/04; B05D 1/38; B05D 5/00; B05D 7/544; B05D 3/107; C09J 2475/00
USPC 428/354; 427/208.8

(57) ABSTRACT

The purpose of the present invention is to provide a re-peelable protective adhesive film having excellent adhesion between a re-peelable adhesive layer and an antistatic layer, having peeling charging preventive properties, and in which air bubbles are unlikely to be incorporated when the film is affixed to a surface of panel or display. This re-peelable protective adhesive film has an antistatic layer on one surface of a transparent resin film, and has re-peelable adhesive layer on the antistatic layer. The antistatic layer is obtained by forming a film from a mixture of an electroconductive polymer and an acrylic emulsion, and the electroconductive polymer and acrylic resin are included in the layer. The re-peelable adhesive layer includes a urethane adhesive and an isocyanate curing agent.

### TECHNICAL FIELD

The present invention relates to re-peelable protective adhesive films having a peeling charging preventive property, which is used for protecting the surface of a touch panel or a flat panel display and the like during manufacture, transport, or storage and the like of the panel or display.

### BACKGROUND ART

In recent years, at the time of manufacture, transport, storage or the like of touch panels or flat panel displays used for various electronic devices such as portable telephones, smart phones, PNDs, tablet PCs, and slate PCs, it is common practice to affix a re-peelable protective adhesive film including a transparent resin film having on one side thereof an adhesive layer with a re-peelable property onto the panel or display surface for temporary protection, so as to prevent scratches, attachment of dirt, or contamination of the panel or display surface.

However, in the case of the conventional protective adhesive film, when the protective adhesive film is peeled from the panel or display surface after performing the role of protecting the panel or display surface, static electricity may be caused. As a result, problems such as destruction of ICs in the circuit, or attachment of dirt or dust on the panel or display surface may occur. In order to prevent such charging upon peeling, a protective adhesive film with peeling charging preventive property is proposed that includes a antistatic layer between a transparent resin film and an adhesive layer, for example (Patent Documents 1 and 2).

Generally, conductive polymers are hydrophilic. Thus, for the adhesive layer disposed on the antistatic layer including a conductive polymer, a material with good adhesion property with the hydrophilic antistatic layer needs to be used. Specifically, in the protective adhesive film described in Patent Document 1, an acrylic adhesive having good adhesion property with the conductive polymer such as polypyrrole is used as the adhesive layer. In the protective adhesive film described in Patent Document 2, a styrene-based block copolymer-based adhesive is used.

### CITATION LIST

### Patent Literatures

Patent Document 1: JP-A-9-207259

Patent Document 2: JP-A-11-181370

### SUMMARY OF THE INVENTION

### Problem to be Solved by the Invention

However, the protective adhesive films using such adhesives may lead to the problems of deterioration in appearance due to bubbles that may easily become trapped when the film is affixed to the panel or display surface, or the difficulty in inspecting the visibility of the panel or display surface. There is also the problem that bits of the adhesive layer may remain on the panel or display surface (problem of paste residue) upon peeling.

Urethane-based adhesives, in contrast to the above-described acrylic adhesive, adhere to the surface of an object by their own wettability, thus eliminating the problems of the entry of bubbles or the paste residue after peeling. However, it is difficult to adjust the adhesion property of an urethane-based adhesive with the hydrophilic antistatic layer. Thus, if an urethane-based adhesive is used as the adhesive layer for the protective adhesive film, interlaminar separation between the antistatic layer and the adhesive layer may be readily caused.

The object of the present invention is to provide a re-peelable protective adhesive film having a peeling charging preventive property that can prevent easy entry of bubbles upon being affixed to a panel or display surface, and that provides excellent adhesion between the adhesive layer and the antistatic layer.

### Solutions to the Problem

The present inventor made the present invention based on the discovery that the above problems can be solved by forming a film of a antistatic layer using a special resin, in addition to the use of a re-peelable adhesive layer based on a urethane-based adhesive.

Namely, a re-peelable protective adhesive film according to the present invention includes a transparent resin film; an antistatic layer disposed on one surface of the transparent resin film; and a re-peelable adhesive layer disposed on the antistatic layer, and is characterized in that the antistatic layer includes a conductive polymer and an acrylic resin, and that the re-peelable adhesive layer includes an isocyanate-based hardener and a urethane-based adhesive.

In the re-peelable protective adhesive film according to the present invention, the antistatic layer includes a film made from a mixture of the conductive polymer and an acrylic emulsion.

Preferably, in the re-peelable protective adhesive film, the antistatic layer includes 12.5 to 250 parts by weight of the conductive polymer with respect to 100 parts by weight of the acrylic resin.

In the re-peelable protective adhesive film, the urethane-based adhesive includes polyol, and the re-peelable adhesive layer preferably includes 5 to 18 parts by weight of the isocyanate-based hardener with respect to 100 parts by weight of the polyol.

A method of manufacturing a re-peelable protective adhesive film according to the present invention includes forming an antistatic layer containing a conductive polymer and an acrylic resin by coating one surface of a transparent resin film with a mixture of the conductive polymer and an acrylic emulsion and then drying; and forming a re-peelable adhesive layer by coating the antistatic layer with a re-peelable adhesive layer paint including a urethane-based adhesive to which an isocyanate-based hardener is added.

The method of manufacturing a peelable protective adhesive film includes a step of causing the acrylic resin in the antistatic layer and the isocyanate-based hardener to react with each other when forming the re-peelable adhesive layer.

### Effects of the Invention

According to the present invention, the antistatic layer includes not just a layer of conductive polymer alone but a layer in which acrylic resin is uniformly mixed, thus facilitating the formation of a urethane-based adhesive layer thereon. In addition, the acrylic resin in the antistatic layer is cross-linked by the isocyanate-based hardener contained in the re-peelable adhesive layer, whereby the adhesion property between the re-peelable adhesive layer and the antistatic layer can be strengthened. As a result, there can be provided a re-peelable protective adhesive film with excellent peelability such that the entry of bubbles is made difficult to occur when affixed to a panel or display surface while maintaining a peeling charging preventive property, and such that the re-peelable adhesive layer and the antistatic layer are not separated upon peeling.

### DESCRIPTION OF EMBODIMENTS

A re-peelable protective adhesive film (which may be hereafter simply referred to as a “protective adhesive film”) according to the present invention includes an antistatic layer on one surface of a transparent resin film and further a re-peelable adhesive layer on the antistatic layer. The antistatic layer is a layer including a conductive polymer and an acrylic resin and being formed from a mixture of the conductive polymer and an acrylic emulsion. The re-peelable adhesive layer includes a urethane-based adhesive including an isocyanate-based hardener. In the following, an embodiment of the respective constituent elements will be described.

The transparent resin film used in the present invention is not particularly limited; however, one with high optical transparency is preferable. Examples include polyethylene terephthalate, polybutylene terephthalate, polyethylene naphthalate, polycarbonate, polyethylene, polypropylene, polystyrene, triacetylcellulose, acrylic, polyvinyl chloride, and norbornene compound. Particularly, a biaxially-stretched polyethylene terephthalate film may be suitably used because of its excellent mechanical strength and dimensional stability. A transparent resin film provided with an easy adhesion treatment by plasma treatment, corona discharge treatment, far-ultraviolet radiation treatment, or by the formation of an undercoating easy adhesion layer may be used.

The thickness of the transparent resin film is not particularly limited; however, from the viewpoint of handling, mechanical strength and the like, the thickness is preferably from 10 to 500 μm and more preferably from 25 to 300 μm.

The antistatic layer disposed on one surface of the transparent resin film will be described. The antistatic layer provides the function of preventing charging that may be caused upon peeling after the protective adhesive film according to the present invention is affixed onto the panel or display surface. When a separator which will be described below is affixed onto the protective adhesive film of the present invention, the antistatic layer also provides the function of preventing the charging that could be caused when peeling the separator.

The antistatic layer may be provided on both surfaces rather than one surface of the transparent resin film. When the antistatic layer is provided on both surfaces, the layers may have the same composition or different compositions. However, the antistatic layer provided with a re-peelable adhesive layer thereon has the antistatic layer configuration as will be described below.

The antistatic layer includes a conductive polymer and an acrylic resin. The antistatic layer has a structure in which the conductive polymer is dispersed in the acrylic resin. In this way, it is believed that charging preventive property and a good adhesion property with respect to the adhesive layer using urethane-based adhesive can be both achieved.

The antistatic layer may be formed by making a film from a mixture of the conductive polymer and an acrylic emulsion. In this way, the acrylic resin and the conductive polymer that have different characteristics can be allowed to coexist in the antistatic layer.

The conductive polymer is provided to give the protective adhesive film of the present invention a peeling charging preventive property, and refers to a π electron conjugated system polymer including a polymerization of monomers having conjugated double bonds in their molecular structures, with an estimated recurring units of 10 to 200. Examples of such π electron conjugated system polymer include polyaniline, polyacetylene, polypyrrole, polythiophene, and a copolymer of one or two kinds selected from the above. Among others, polythiophene or polyaniline may be suitably used from the viewpoint of exhibiting high peeling charging preventive property and excellent adhesion with the re-peelable adhesive layer which will be described below.

Preferably, the conductive polymer contains a dopant from the viewpoint of improving conductivity. Examples of the dopant include organic acids such as a halogen compound, a Lewis acid, a proton acid, an organic carboxylic acid, or an organic sulfonic acid; an organic cyano compound; fullerene; hydrogenated fullerene; carboxylated fullerene; and sulfonated fullerene.

Preferably, the electrical conductivity of the conductive polymer per se is from 10⁻³ to 10³ S/cm. The electrical conductivity of not less than 10⁻³ S/cm is preferable because this makes it possible to obtain a protective adhesive film with high peeling charging preventive property even when the thickness of the antistatic layer is decreased.

Next, the acrylic resin contained in the antistatic layer is used not only for improving adhesion with the transparent resin film, but also because a part of the acrylic resin is cross-linked with the multifunctional isocyanate-based hardener contained in the re-peelable adhesive layer, which will be described below, when forming a coated film, thus providing excellent adhesion between the antistatic layer and the re-peelable adhesive layer.

Examples that may be used as the acrylic resin include copolymers, such as acrylic polymer or acrylic-styrene copolymer, and self-crosslinking acrylic copolymers that have a free hydroxyl group. Specific examples that may be used are polymers of one or two kinds of (metha) acrylate compounds such as alkyl (metha) acrylates, such as methyl (metha) acrylate, ethyl (metha) acrylate, butyl (metha) acrylate, and 2-ethyl hexyl (metha) acrylate; and copolymers of these monomers and vinyl compounds copolymerizable therewith, such as styrene, vinyl acetate, or vinylidene chloride.

These acrylic resins are used in the form of a polymer emulsion. The use in the form of emulsion makes it possible to easily make a structure in which a conductive polymer and an acrylic resin are uniformly mixed in a single layer. The solid portion in the emulsion is not particularly limited; normally, however, the solid content is on the order of from 30 wt % to 70 wt %.

The conditions under which the film is formed using the acrylic emulsion are adjusted depending on the copolymerization ratio of the monomers including the emulsion, and the type and amount of the added film-forming additive agent or plasticizer, for example, and therefore cannot be definitely stated. However, it is preferable to perform heating at a minimum film-forming temperature of 60° C. or more and 120° C. or less for 10 seconds to 3 minutes.

When the acrylic emulsion is used, the content ratio of the conductive polymer and the acrylic resin in the antistatic layer is preferably 25 to 500 parts by weight of the conductive polymer with respect to 100 parts by weight of the acrylic emulsion. The ratio of the acrylic resin and the conductive polymer is preferably 12.5 to 250 parts by weight of the conductive polymer with respect to 100 parts by weight of the acrylic resin. When the content of the conductive polymer is 25 parts by weight or more with respect to 100 parts by weight of the acrylic emulsion (12.5 parts by weight or more with respect to 100 parts by weight of acrylic resin), sufficient charging preventive property can be more readily obtained. When the content of the conductive polymer is 500 parts by weight or less with respect to 100 parts by weight of the acrylic emulsion (250 parts by weight or less with respect to 100 parts by weight of acrylic resin), not only the adhesion with the transparent resin film but also the adhesion with the re-peelable adhesive layer can be improved. A lower limit of 50 parts by weight or more with respect to 100 parts by weight of the acrylic emulsion (25 parts by weight or more with respect to 100 parts by weight of acrylic resin) may be more preferable. Further, an upper limit of 300 parts by weight or less with respect to 100 parts by weight of the acrylic emulsion (150 parts by weight or less with respect to 100 parts by weight of acrylic resin) may be more preferable.

The antistatic layer may contain an additive, such as a film-forming additive agent, a plasticizer, an antioxidant, an ultraviolet absorbing agent, a light stabilizer, a thermal polymerization inhibitor, a levelling agent, a surfactant, or a glidant, to the extent that the effect of the present invention would not be inhibited, depending on the purpose of use.

The thickness of the antistatic layer is preferably 0.5 to 5 μm and more preferably 1 to 3 μm from the viewpoint of achieving sufficient charging preventive property or facilitating adhesion retention of the re-peelable adhesive layer.

Next, the re-peelable adhesive layer formed on the antistatic layer will be described. The re-peelable adhesive layer includes a urethane-based adhesive and an isocyanate-based hardener. The re-peelable adhesive layer provides the function of enabling the protective adhesive film of the present invention to be affixable onto the panel or display surface, and also of facilitating peeling after the affixing. When the antistatic layer is formed on both surfaces of the transparent resin film, the re-peelable adhesive layer may be provided only on one of the antistatic layers or both of the antistatic layers, depending on the mode of use.

The urethane-based adhesive is used to make it difficult for the entry of bubbles when affixing onto the affixed member, and also to express re-peeling tackiness when formed as a coated film. In order to cause the expression of re-peeling tackiness, an acrylic adhesive may be used. However, an acrylic adhesive may invite the entry of bubbles when affixed onto the panel or display surface and is therefore not suitable. On the other hand, the use of urethane-based adhesive can make it more difficult for bubbles to enter, or enables the bubbles that have entered to be let out from the film edge in a short period, thus eliminating the problem of bubble entry.

The urethane-based adhesive includes a compound that forms a urethane bond by reacting with the isocyanate-based hardener. Examples of the compound are polyols such as polyester polyol, polyether polyol, polycarbonate polyol, and polycaprolactone polyol.

The isocyanate-based hardener is used not only for improving the cohesive force of the re-peelable adhesive layer by cross-linking with the polyol included in the urethane-based adhesive, but also to improve adhesion between the antistatic layer and the re-peelable adhesive layer by cross-linking with a part of the acrylic resin included in the antistatic layer. While generally available one-component curable or a two-component curable urethane-based adhesives contain an isocyanate-based hardener, adhesion with the antistatic layer can be further improved by further adding an isocyanate-based hardener into the urethane-based adhesive.

The isocyanate-based hardener may be a multifunctional compound having two or more isocyanate groups. Examples are aromatic diisocyanates, such as diphenylmethane diisocyanate, 2,4-tolylene diisocyanate, 2,6-tolylene diisocyanate, phenylene diisocyanate, 1,5-naphthylene diisocyanate, xylylene diisocyanate, or toluylenediisocyanate; and aliphatic or alicyclic diisocyanates, such as hexamethylene diisocyanate, isophorone diisocyanate, or 4,4′-dicyclohexyl methane diisocyanate.

The content ratio of polyol and isocyanate-based hardener is determined by the NCO group value of the isocyanate-based hardener and the like, and therefore cannot be definitely stated; however, it is preferable that 5 to 18 parts by weight of the isocyanate-based hardener is contained with respect to 100 parts by weight of polyol. When 5 parts by weight or more of the isocyanate-based hardener is contained, the cohesive force of the re-peelable adhesive layer and adhesion between the re-peelable adhesive layer and the antistatic layer can be improved. When the content is 18 parts by weight or less, the increased tendency of entry of bubbles due to hardening of the coated film can be prevented, whereby adhesion retention property with the re-peelable adhesive layer can be more readily improved. More preferably, the lower limit is 8 parts by weight and the upper limit is 14 parts by weight.

When a one-component curable or two-component curable urethane-based adhesive that contains isocyanate-based hardener is used, preferably 3.5 to 8 parts by weight and more preferably 4 to 8 parts by weight of the isocyanate-based hardener with respect to 100 parts by weight of the urethane-based adhesive may be used.

Preferably, the content of the NCO group in the isocyanate-based hardener is 5 to 20% when the solid portion is 75%. When the content is 5% or more, the cohesive force of the re-peelable adhesive layer and the adhesion between the re-peelable adhesive layer and the antistatic layer can be improved. Meanwhile, when the content is 20% or less, the increased likelihood of entry of bubbles due to hardening of the coated film can be prevented. The content of the NCO group is preferably from 7.5 to 15%.

The re-peelable adhesive layer may contain an additive to the extent that the effect of the present invention would not be inhibited, depending on the purpose of use. Examples are a colorant or pigment powder; surfactant; plasticizer; tackifier; low molecular weight polymer; surface lubricant; leveling agent; antioxidant; corrosion inhibitor; light stabilizer; ultraviolet absorbing agent; polymerization inhibitor; silane coupling agent; inorganic or organic filler; and a metal in the form of a powder, particles, or foil.

The thickness of the re-peelable adhesive layer is preferably 1 to 30 μm from the viewpoint of ease of peeling and handling of the protective adhesive film, for example.

The surface resistivity of the protective adhesive film of the present invention is preferably 1.0×10¹⁰Ω/□ or less in terms of a measurement value according to JIS K 6911: 1995 in a plane including the re-peelable adhesive layer of the protective adhesive film, from the viewpoint of achieving peeling charging preventive performance.

In order to improve handling, it is preferable to provide the re-peelable protective adhesive film of the present invention with a separator on a re-peelable adhesive layer surface. The separator is not particularly limited; examples are polyethylene laminated paper; plastic films of polypropylene, polyethylene, polyester, polycarbonate, triacetylcellulose, polyvinyl chloride, acrylic, polystyrene, polyamide, polyimide, or vinylidene chloride-vinyl chloride copolymer; and such a plastic film provided with release treatment on one surface thereof.

The thickness of the separator is not particularly limited; generally, the thickness is 10 μm to 250 μm and preferably 20 μm to 125 μm.

The re-peelable protective adhesive film according to the present invention may be manufactured by the following manufacturing method. First, a conductive polymer is added into the acrylic emulsion and uniformly mixed to prepare a antistatic layer coating liquid. The coating liquid is applied onto the above-described transparent resin film by a coating method well known in the art, using a bar coater, a die coater, a blade coater, a spin coater, a roll coater, a gravure coater, a flow coater, spraying, or screen printing, for example, followed by drying as needed at a relatively low drying temperature (such as 60° C. to 120° C. for 10 seconds to 3 minutes), thus forming the antistatic layer. Meanwhile, polyol or a urethane-based adhesive and an isocyanate-based hardener are mixed to obtain a re-peelable adhesive layer coating liquid, which is applied onto the antistatic layer by a well-known coating method, forming the re-peelable adhesive layer. The re-peelable adhesive layer will be formed into a film as the polyol reacts with the isocyanate-based hardener over time without providing a special curing step; however, drying may be performed at a relatively low drying temperature of 60° C. to 100° C. for 1 to 72 hours or so. Thereafter, the above-described separator may be affixed onto the top of the re-peelable adhesive layer as needed.

Alternatively, a antistatic layer may be formed on one surface of the transparent resin film in the same way as described above, while a re-peelable adhesive layer may be formed on the separator in the same way as described above. Thereafter, the surface of the transparent resin film on which the antistatic layer is formed and the surface of the separator on which the re-peelable adhesive layer is formed may be affixed to each other, thereby obtaining the re-peelable protective adhesive film according to the present invention.

While an example of the method of manufacturing the re-peelable protective adhesive film according to the present invention has been described, the present invention is not limited to such example. For example, the re-peelable protective adhesive film may be manufactured by forming the re-peelable adhesive layer, the antistatic layer, and the transparent resin film on the separator successively.

Regarding the manufacturing method for the re-peelable protective adhesive film, from the viewpoint of achieving a sufficient adhesion between the antistatic layer and the re-peelable adhesive layer by cross-linking the acrylic resin in the acrylic emulsion contained in the antistatic layer coating liquid and the isocyanate-based hardener contained in the re-peelable adhesive layer coating liquid, it is preferable not to let the antistatic layer and the re-peelable adhesive layer react completely before they are affixed to each other. Specifically, the re-peelable adhesive layer coating liquid is applied onto the antistatic layer before the antistatic layer completely dries and cures and before the polyol and isocyanate in the re-peelable adhesive layer are completely reacted.

As described above, in the re-peelable protective adhesive film according to the present invention, in addition to using the re-peelable adhesive layer based on a urethane-based adhesive, a film of the antistatic layer is formed from an acrylic emulsion containing a conductive polymer. Thus, no charging is caused and the development of interlaminar separation can be prevented upon peeling even when the film is affixed at the time of manufacture, transport, or storage and the like of a touch panel or flat panel display.

### EXAMPLES

In the following, the present invention will be described in further detail with reference to Examples. In the present Examples, “parts” and “%” are with reference to weight unless otherwise specifically noted.

### 1. Fabrication of Re-Peelable Protective Adhesive Film

### Example 1

One surface of a polyethylene terephthalate film (Emblet S50: Unitika Ltd.) with a thickness of 50 μm as the transparent resin film was coated with the antistatic layer coating liquid according to the following formula by bar coater method and then dried at 100° C. for one minute, forming a antistatic layer with a thickness of 2 μm. Then, the antistatic layer was coated with the re-peelable adhesive layer coating liquid according to the following formula by bar coater method and dried at 60° C. for 72 hours, forming a re-peelable adhesive layer with a thickness of 10 μm, followed by drying of the antistatic layer and the re-peelable adhesive layer. Thereafter, onto the re-peelable adhesive layer was affixed a lubricating-treated surface of a separator (polyethylene naphthalate film with a thickness of 25 μm, or MRF: Mitsubishi Polyester Film, Inc.), fabricating the re-peelable protective adhesive film according to Example 1.

### Antistatic Layer Coating Liquid for Example 1

| | |
|---|---|
| Mixture of conductive polymer and acrylic emulsion | 50 parts |
| (SEPLEGYDA AS-D06: Shin-Etsu Finetech Co., Ltd., | |
| solid portion 13.5%) | |
| Methanol | 75 parts |
| Water | 75 parts |

### Re-Peelable Adhesive Layer Coating Liquid of Example 1

| | |
|---|---|
| Urethane-based adhesive | 30 parts |
| (US-902: Ipposha Oil Industries Co., Ltd., | |
| solid portion 60%) | |
| Isocyanate-based hardener | 1.92 parts |
| (Takenate D110N: Mitsui Chemicals, Inc., solid | |
| portion 60%, NCO group | |
| content 7.2%) | |
| Diluting solvent | 50 parts |

### Example 2

A re-peelable adhesive film according to Example 2 was fabricated in the same way as for Example 1 with the exception that the amount of the isocyanate-based hardener of Example 1 added was 3 parts by weight.

### Example 3

A re-peelable adhesive film according to Example 3 was fabricated in the same way as for Example 1 with the exception that the amount of the isocyanate-based hardener of Example 1 added was 1 part by weight.

### Comparative Example 1

A re-peelable adhesive film according to Comparative Example 1 was fabricated in the same way as for Example 1 with the exception that the isocyanate-based hardener was removed from the re-peelable adhesive layer coating liquid of Example 1.

### Comparative Example 2

A re-peelable adhesive film according to Comparative Example 2 was fabricated in the same way as for Example 1 with the exception that the mixture of the conductive polymer and the acrylic emulsion of the antistatic layer coating liquid of Example 1 was replaced by a conductive polymer alone (SEPLEGYDA SAS-PE-S03: Shin-Etsu Polymer Co., Ltd.).

### Comparative Example 3

A re-peelable adhesive film according to Comparative Example 3 was fabricated in the same way as for Example 1 with the exception that the mixture of the conductive polymer and the acrylic emulsion of the antistatic layer coating liquid of Comparative Example 1 was replaced by a conductive polymer alone (SEPLEGYDA SAS-PE-S03: Shin-Etsu Polymer Co., Ltd.).

### Comparative Example 4

A re-peelable adhesive film according to Comparative Example 4 was fabricated in the same way as for Example 1 with the exception that the re-peelable adhesive layer coating liquid of Comparative Example 1 was replaced by a re-peelable adhesive layer coating liquid of the following formula.

### Re-Peelable Adhesive Layer Coating Liquid of Comparative Example 4

| | |
|---|---|
| Acrylic adhesive | 50 parts |
| (Paracron W-248E: Negami Chemical Industrial Co., Ltd, | |
| solid portion 30%) | |
| Isocyanate-based hardener | 2 parts |
| (OLESTER NP-1200: Mitsui Chemicals, Inc., solid portion | |
| 70%, NCO | |
| group content 7%) | |
| Diluting solvent | 50 parts |

### 2. Evaluation

### (1) Bubble Entry Preventive Property

The separator was removed from each of the re-peelable protective adhesive films of Examples 1 to 3 and Comparative Examples 1 to 4, thus exposing the re-peelable adhesive layer. The re-peelable protective adhesive film was then caused to adhere, by its own weight, onto the affixed member of A. stainless plate (SUS 304 steel plate according to JIS G 4305), B. glass plate, and C. acrylic plate. Thereafter, the surface of the closely adhered re-peelable protective adhesive film was visually observed. The re-peelable protective adhesive film where the bubbles had left from the edge of the re-peelable protective adhesive film within less than 5 seconds after adhesion was evaluated to be “Excellent”. The re-peelable protective adhesive film where the bubbles had left from the edge of the re-peelable protective adhesive film in 5 seconds or more and less than 10 seconds after adhesion was evaluated to be “Good”. At 10 seconds after adhesion, the re-peelable protective adhesive film where the bubbles were visually identifiable at the ratio of less than 20% per 40 cm² surface area of the re-peelable protective adhesive film was evaluated to be “Poor”, and those where the bubbles were visually identifiable at the ratio of 20% or more was evaluated to be “Bad”. The measurement results are shown in Table 1.

### (2) Adhesion

The separator was peeled from each of the re-peelable protective adhesive films of Examples 1 to 3 and Comparative Examples 1 to 4, thus exposing the re-peelable adhesive layer. The surface of the re-peelable adhesive layer was then scrubbed with finger to confirm the initial adhesion between the re-peelable adhesive layer and the antistatic layer. The re-peelable protective adhesive film where the re-peelable adhesive layer was separated from the antistatic layer was evaluated to be “None”.

Thereafter, with regard to the re-peelable protective adhesive films where the re-peelable adhesive layer was not separated from the antistatic layer, the surface of the re-peelable protective adhesive film that includes the re-peelable adhesive layer was affixed to a stainless plate as the affixed member, and then allowed to stand in the environment of ambient temperature of 60° C. for 4 days. The re-peelable protective adhesive film where the bonding force between the stainless plate and the re-peelable adhesive layer had been increased so that the re-peelable adhesive layer was left attached onto the stainless plate upon peeling of the re-peelable protective adhesive film from the stainless plate was evaluated to be “Very bad”.

Thereafter, with regard to the re-peelable protective adhesive films where the re-peelable adhesive layer could be peeled without remaining on the stainless plate even after the elapse of the above change over time, the surface of the re-peelable adhesive layer was scrubbed while applying a load of 1 kg with a metal piece with a cross sectional area of 0.1 cm² to confirm a change over time in the adhesion between the re-peelable adhesive layer and the antistatic layer. The re-peelable protective adhesive film where the re-peelable adhesive layer did not peel off the antistatic layer even when scrubbed with the metal piece in 20 or more back-and-forth movements was evaluated to be “Excellent”. Where the re-peelable adhesive layer did not peel off the antistatic layer after rubbing with the metal piece in 10 or more and less than 20 back-and-forth movements, the re-peelable protective adhesive film was evaluated to be “Good”. Where the re-peelable adhesive layer peeled off the antistatic layer by the rubbing with the metal piece in less than 10 back-and-forth movements, the re-peelable protective adhesive film was evaluated to be “Bad”. The measurement results are shown in Table 1.

TABLE 1

| | Bubble Entry | | | |
|---|---|---|---|---|
| | Preventive Property | | | |
| | A. Stainless Steel | | C. Acrylic | |
| | Plate | B. Glass Plate | Plate | Adhesion |
| Example 1 | Excellent | Excellent | Excellent | Excellent |
| Example 2 | Good | Good | Good | Excellent |
| Example 3 | Excellent | Excellent | Excellent | Good |
| Comparative | Poor | Poor | Poor | None |
| Example 1 | | | | |
| Comparative | Good | Good | Good | Bad |
| Example 2 | | | | |
| Comparative | Poor | Poor | Poor | None |
| Example 3 | | | | |
| Comparative | Bad | Bad | Bad | Very Bad |
| Example 4 | | | | |

The results in Table 1 shows that, since the re-peelable protective adhesive films according to Examples 1 to 3 are re-peelable protective adhesive films having, successively formed on the transparent resin film, the acrylic resin-containing film of antistatic layer formed from a conductive polymer and an acrylic emulsion, and the re-peelable adhesive layer containing a urethane-based adhesive and an isocyanate-based hardener, there was no entry of bubbles when the presence or absence of bubble entry was confirmed by affixing the re-peelable protective adhesive films onto the affixed member of A. stainless plate, B. glass plate, and C. acrylic plate. The adhesion between the re-peelable adhesive layer and the antistatic layer was also good.

In particular, in the re-peelable protective adhesive film according to Example 1, where the content ratio of the urethane-based adhesive and the isocyanate-based hardener was in the range of 3.5 to 8 parts by weight of the isocyanate-based hardener with respect to 100 parts by weight of the urethane-based adhesive (the content ratio of the polyol and the isocyanate-based hardener is within the range of 5 to 18 parts by weight of the isocyanate-based hardener with respect to 100 parts by weight of polyol), the bubble entry preventive property was particularly excellent with respect to any of A. stainless plate, B. glass plate, and C. acrylic plate, and the adhesion property in terms of change over time was also excellent.

When the surface resistivity (Ω/□) of the surface of the re-peelable adhesive films according to Examples 1 to 3 having the re-peelable adhesive layer was measured according to JIS K 6911: 1995, the surface resistivity was less than 1.0×10¹⁰Ω/□ in each case, thus also showing excellent peeling charging preventive property.

On the other hand, in the case of the re-peelable adhesive films according to Comparative Examples 1 and 3, because the re-peelable adhesive layer did not contain the isocyanate-based hardener, the re-peelable adhesive layer did not cross-link and did not provide the function of a re-peelable adhesive layer, exhibiting poor initial adhesion.

The re-peelable adhesive film according to Comparative Example 2 included the urethane-based adhesive and the isocyanate-based hardener in the re-peelable adhesive layer and therefore provided initial adhesion. However, since the antistatic layer did not contain acrylic resin, the adhesion between the re-peelable adhesive layer and the antistatic layer was poor, and interlaminar separation occurred when scrubbed with a nail.

In the re-peelable adhesive film according to Comparative Example 4, because the re-peelable adhesive layer included an acrylic adhesive rather than a urethane-based adhesive, bubble entry occurred with respect to all of the affixed members of A. stainless plate, B. glass plate, and C. acrylic plate, resulting in poor appearance. In terms of adhesion evaluation, the re-peelable adhesive layer became attached to the stainless plate and failed to provide the re-peelable function, and the adhesion between the antistatic layer and the re-peelable adhesive layer was also poor.

1-7. (canceled)

8. A re-peelable protective adhesive film comprising:
a transparent resin film;
an antistatic layer disposed on one surface of the transparent resin film; and
a re-peelable adhesive layer disposed on the antistatic layer,
wherein the antistatic layer includes a conductive polymer and an acrylic resin; and
the re-peelable adhesive layer includes an isocyanate-based hardener and a urethane-based adhesive.

9. The re-peelable protective adhesive film according to claim 8, wherein the antistatic layer is a film formed from a mixture of the conductive polymer and an acrylic emulsion.

10. The re-peelable protective adhesive film according to claim 8, wherein the antistatic layer includes 12.5 to 250 parts by weight of the conductive polymer with respect to 100 parts by weight of the acrylic resin.

11. The re-peelable protective adhesive film according to claim 8, wherein the urethane-based adhesive includes polyol, and the re-peelable adhesive layer includes 5 to 18 parts by weight of the isocyanate-based hardener with respect to 100 parts by weight of the polyol.

12. The re-peelable protective adhesive film according to claim 8, comprising a antistatic layer on another surface of the transparent resin film.

13. A method of manufacturing a re-peelable protective adhesive film including a antistatic layer and a re-peelable adhesive layer on a transparent resin film, the method comprising:
forming a antistatic layer containing a conductive polymer and an acrylic resin by coating one surface of the transparent resin film with a mixture of the conductive polymer and an acrylic emulsion and then drying; and
forming a re-peelable adhesive layer by coating the antistatic layer with a re-peelable adhesive layer paint including a urethane-based adhesive to which an isocyanate-based hardener is added.

14. The method of manufacturing a re-peelable protective adhesive film according to claim 13, wherein when forming the re-peelable adhesive layer, the acrylic resin in the antistatic layer and the isocyanate-based hardener are caused to react with each other.

15. The re-peelable protective adhesive film according to claim 9, wherein the antistatic layer includes 12.5 to 250 parts by weight of the conductive polymer with respect to 100 parts by weight of the acrylic resin.

16. The re-peelable protective adhesive film according to claim 9, wherein the urethane-based adhesive includes polyol, and the re-peelable adhesive layer includes 5 to 18 parts by weight of the isocyanate-based hardener with respect to 100 parts by weight of the polyol.

17. The re-peelable protective adhesive film according to claim 10, wherein the urethane-based adhesive includes polyol, and the re-peelable adhesive layer includes 5 to 18 parts by weight of the isocyanate-based hardener with respect to 100 parts by weight of the polyol.

18. The re-peelable protective adhesive film according to claim 9, comprising a antistatic layer on another surface of the transparent resin film.

19. The re-peelable protective adhesive film according to claim 10, comprising a antistatic layer on another surface of the transparent resin film.

20. The re-peelable protective adhesive film according to claim 11, comprising a antistatic layer on another surface of the transparent resin film.
